(19) United States
(12) Patent Application Publication
(10) Pub. No.: US 2024/0382038 A1
(43) Pub. Date: Nov. 21, 2024

(54) METHOD FOR COOKING SOUP, STORAGE MEDIUM, COOKING APPARATUS AND COOKING DEVICE

(71) Applicant: FOSHAN SHUNDE MIDEA ELECTRICAL HEATING APPLIANCES MANUFACTURING CO., LTD., Foshan (CN)

(72) Inventor: Qingsong GU, Foshan (CN)

(21) Appl. No.: 18/662,662

(22) Filed: May 13, 2024

(30) Foreign Application Priority Data
May 16, 2023 (CN) 202310555650.1

(51) Int. Cl. A47J 36/32; A47J 27/08

(52) U.S. Cl. CPC A47J 36/32; A47J 27/0802

(57) ABSTRACT

A method for cooking includes heating a cooking chamber of a cooking device to a first temperature, to enter a first cooking stage, keeping a temperature of the cooking chamber at the first temperature at the first cooking stage, heating the cooking chamber to a second temperature greater than the first temperature after the first cooking stage, to enter a second cooking stage, and keeping the temperature of the cooking chamber at the second temperature at the second cooking stage.

### CROSS-REFERENCE TO RELATED APPLICATION

This application claims priority to Chinese Application No. 202310555650.1, filed on May 16, 2023, the entire content of which is incorporated herein by reference.

### TECHNICAL FIELD

The disclosure relates to the technical field of cooking, and in particular to a method for cooking soup, a storage medium, a cooking apparatus, and a cooking device.

### BACKGROUND

Some food materials have certain fishy smell, and the fishy smell of the food materials needs to be removed in a process of cooking soup. In the related art, time for removing the fishy smell is relatively long.

### SUMMARY

In view of this, embodiments of the disclosure are desired to provide a method for cooking soup, a storage medium, a cooking apparatus, and a cooking device, to shorten the time for removing the fishy smell.

In order to achieve the above purpose, a first aspect of the embodiments of the disclosure provides a method for cooking soup, the method includes the following operations.

A cooking chamber is heated to a first temperature, to enter a protein hydrolysis stage.

The temperature of the cooking chamber is kept at the first temperature at the protein hydrolysis stage.

The cooking chamber is heated to a second temperature after the protein hydrolysis stage, to enter a fishy smell removal stage, the second temperature is greater than the first temperature.

The temperature of the cooking chamber is kept at the second temperature at the fishy smell removal stage.

In an embodiment, the method may further include the following operations.

The protein hydrolysis stage is finished when time duration for keeping the cooking chamber at the first temperature at the protein hydrolysis stage reaches a first time duration, the first time duration is 10 minutes to 40 minutes.

In an embodiment, the method may further include the following operations.

The fishy smell removal stage is finished when time duration for keeping the cooking chamber at the second temperature at the fishy smell removal stage reaches a second time duration, the second time duration is 1 minute to 10 minutes.

In an embodiment, a cooking device may be a pressure cooker, pressurization temperature of the cooking chamber is a third temperature, and the third temperature is greater than the second temperature.

In an embodiment, the method may further include the following operations.

The cooking chamber is heated to a preset condition when time duration for keeping the cooking chamber at the second temperature at the fishy smell removal stage reaches a second time duration.

The cooking chamber is kept at the preset condition, until cooking is finished.

The preset condition is that the temperature of the cooking chamber is a fourth temperature, and the fourth temperature is greater than the third temperature; and/or, pressure of the cooking chamber is a preset pressure, and the preset pressure is greater than pressure in the cooking chamber at a pressurization time.

In an embodiment, the fourth temperature may be equal to or greater than 106° C., and the fourth temperature is less than or equal to 128° C.; and/or, the pressure of the cooking chamber is equal to or greater than 30 KPa, and the pressure of the cooking chamber is less than or equal to 140 KPa.

In an embodiment, power for heating the cooking chamber in a process of heating the cooking chamber to the preset condition may be a fifth power, power for heating the cooking chamber in a process of keeping the cooking chamber at the preset condition is a sixth power, and the fifth power is greater than the sixth power; or, the fifth power is equal to or greater than 700 W, and the sixth power is less than or equal to 400 W.

In an embodiment, the first temperature may be equal to or greater than 40° C., and the first temperature is less than or equal to 70° C.; and/or, the second temperature is equal to or greater than 92° C., and the second temperature is less than or equal to 100° C.

In an embodiment, power for heating the cooking chamber in a process of heating the cooking chamber to the first temperature may be a first power, power for heating the cooking chamber in a process of keeping the cooking chamber at the first temperature at the protein hydrolysis stage is a second power, and the first power is greater than the second power; or, the first power is equal to or greater than 700 W, and the second power is less than or equal to 400 W; or, power for heating the cooking chamber in a process of heating the cooking chamber to the second temperature is a third power, power for heating the cooking chamber in a process of keeping the cooking chamber at the second temperature at the fishy smell removal stage is a fourth power, and the third power is greater than the fourth power; or, the third power is equal to or greater than 700 W, and the fourth power is less than or equal to 400 W.

A second aspect of the embodiments of the disclosure provides a storage medium, the storage medium stores a computer-executable instruction, the computer-executable instruction is configured to be executed by a processor to implement operations of the method as described in any one of the above paragraphs.

A third aspect of the embodiments of the disclosure provides a cooking apparatus, the cooking apparatus includes a first heating module, a first heat preservation module, a second heating module, and a second heat preservation module.

The first heating module is configured to heat a cooking chamber to a first temperature, to enter a protein hydrolysis stage.

The first heat preservation module is configured to keep the temperature of the cooking chamber at the first temperature at the protein hydrolysis stage.

The second heating module is configured to heat the cooking chamber to a second temperature after the protein hydrolysis stage, to enter a fishy smell removal stage, the second temperature is greater than the first temperature.

The second heat preservation module is configured to keep the temperature of the cooking chamber at the second temperature at the fishy smell removal stage.

A fourth aspect of the embodiments of the disclosure provides a cooking device, the cooking device includes a memory and a processor.

The memory stores a computer-executable instruction.

The processor is configured to execute the computer-executable instruction stored in the memory, to implement operations of the method as described in any one of the above paragraphs.

In the method for cooking soup according to the embodiment of the disclosure, protein may be better hydrolyzed at a specific temperature, the first temperature is a temperature at which the protein is easily hydrolyzed, and the temperature of the cooking chamber is kept at the first temperature at the protein hydrolysis stage, so that the protein may be relatively fully hydrolyzed. The protein is hydrolyzed into amino acid, which may improve umami taste and mellow taste. Substances providing the umami taste after the protein hydrolysis may regulate sodium ions, activate taste receptors, enhance salty taste, compensate for taste difference caused by reduction of salt, and achieve a purpose of improving the umami taste while adding less salt. The protein hydrolysis stage itself needs to last for a period of time, to fully hydrolyze the protein. In this period of the protein hydrolysis, fishy smell substances in food may be dissolved from the food to the soup. Since a large number of fishy smell substances are dissolved into the soup at the protein hydrolysis stage, the protein hydrolysis and dissolution of the fishy smell substances in the food may be performed almost simultaneously, saving time for dissolving the fishy smell substances separately. After the protein hydrolysis stage, temperature in the cooking chamber is heated to a higher second temperature, and the fishy smell substances dissolved from the food to the soup are relatively quickly volatilized along with vapor at the higher second temperature, to achieve a purpose of quickly removing the fishy smell. The method for cooking soup according to the embodiment of the disclosure, may not only improve umami taste of the soup through the protein hydrolysis, and perform dissolution of fishy smell substances and the protein hydrolysis simultaneously as much as possible, without dissolving fishy smell substances in food separately; but also enable the fishy smell substances to be volatilized relatively quickly, to shorten time for removing the fishy smell.

### BRIEF DESCRIPTION OF THE DRAWINGS

FIG. 1 is a flowchart of a method for cooking soup according to an embodiment of the disclosure, in which main operations of the method for cooking soup are shown.

FIG. 2 is a flowchart of a method for cooking soup according to an embodiment of the disclosure, in which conditions of finishing a protein hydrolysis stage are shown.

FIG. 3 is a flowchart of a method for cooking soup according to an embodiment of the disclosure, in which conditions of finishing a fishy smell removal stage are shown.

FIG. 4 is a flowchart of a method for cooking soup according to an embodiment of the disclosure, in which operations of a pressure cooker after a fishy smell removal stage is shown.

FIG. 5 is a flowchart of a method for cooking soup according to an embodiment of the disclosure, in which conditions of finishing cooking are shown.

FIG. 6 is a flowchart of a method for cooking soup according to an embodiment of the disclosure, in which a complete flow of the method for cooking soup is shown.

### DETAILED DESCRIPTION

It should be noted that embodiments of the disclosure and technical features thereof may be combined with each other without conflict, and detailed descriptions in specific implementations should be understood as explanation and illustration of the object of the disclosure and should not be considered as undue limitation to the disclosure.

As a part of creative conception of the disclosure, before describing the embodiments of the disclosure, it is necessary to analyze the reason why time for removing fishy smell is relatively long in the related art, and obtain technical solutions of the embodiments of the disclosure through reasonable analysis.

In the related art, a cooking chamber is directly heated to a high temperature, and fishy smell substances in soup and food may volatilize at the high temperature. For example, the fishy smell substances include ammonia, hydrogen sulfide, trimethylamine, etc. It is found by the inventor through research that since the cooking chamber is directly heated to the high temperature to remove the fishy smell, most of the fishy smell substances in the food remain in food materials and have not been dissolved into the soup; a volatilization speed of the fishy smell substances in the food is relatively slow, even though they are volatilized at the high temperature; when the fishy smell substances in the food are dissolved into the soup, the fishy smell substances in the soup may be volatilized and discharged relatively quickly with vapor.

In view of this, an embodiment of the disclosure provides a cooking device, the cooking device is provided with a cooking chamber, and the cooking chamber is configured to cook soup through food.

In an embodiment, the cooking device may be a cooking device of which a cooking chamber cannot be pressurized. For example, the cooking device may be an open casserole for cooking soup.

In an embodiment, the cooking device may be a pressure cooker of which a cooking chamber may be pressurized.

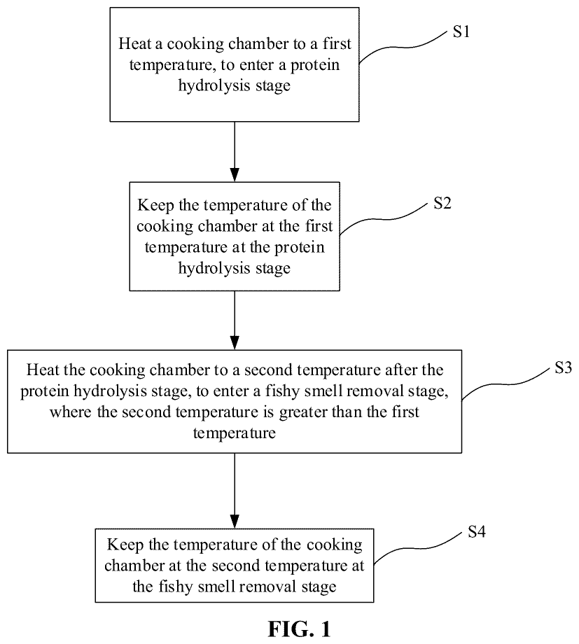

A method for cooking soup refers to FIG. 1, the method for cooking soup includes the following operations S1 and S2.

At S1, a cooking chamber is heated to a first temperature, to enter a protein hydrolysis stage. The protein hydrolysis stage is an example of a first cooking stage.

At S2, the temperature of the cooking chamber is kept at the first temperature at the protein hydrolysis stage.

It may be understood that protein may be better hydrolyzed at a specific temperature, the first temperature is a temperature at which the protein is easily hydrolyzed, and the temperature of the cooking chamber is kept at the first temperature at the protein hydrolysis stage, so that the protein may be relatively fully hydrolyzed. The protein is hydrolyzed into amino acid, which may improve umami taste and mellow taste. Substances providing the umami taste after the protein hydrolysis may regulate sodium ions, activate taste receptors, enhance salty taste, compensate for taste difference caused by reduction of salt, and achieve a purpose of improving the umami taste while adding less salt. The protein hydrolysis stage itself needs to last for a period of time, to fully hydrolyze the protein. In this period of the protein hydrolysis, fishy smell substances in food may be dissolved from the food to the soup.

It should be noted that protein hydrolysis processes are substantially as follows: protein→albumose→peptone→polypeptide→dipeptide→amino acid. The protein is hydrolyzed to form the amino acid finally.

In an embodiment, with reference to FIG. 1, the method for cooking soup further includes the following operations S3 and S4.

At S3, the cooking chamber is heated to a second temperature after the protein hydrolysis stage, to enter a fishy smell removal stage, the second temperature is greater than the first temperature. The fishy smell removal stage is an example of a second cooking stage.

At S4, the temperature of the cooking chamber is kept at the second temperature at the fishy smell removal stage.

Since a large number of fishy smell substances are dissolved into the soup at the protein hydrolysis stage, the protein hydrolysis and dissolution of the fishy smell substances in the food may be performed almost simultaneously, saving time for dissolving the fishy smell substances separately. After the protein hydrolysis stage, temperature in the cooking chamber is heated to a higher second temperature, and the fishy smell substances dissolved from the food to the soup are relatively quickly volatilized along with vapor at the higher second temperature, to achieve a purpose of quickly removing the fishy smell. The method for cooking soup according to the embodiment of the disclosure, may not only improve umami taste of the soup through the protein hydrolysis, and perform dissolution of fishy smell substances and the protein hydrolysis simultaneously as much as possible, without dissolving fishy smell substances in food separately; but also enable the fishy smell substances to be volatilized relatively quickly, to shorten time for removing the fishy smell.

In an embodiment, power for heating the cooking chamber in a process of heating the cooking chamber to the first temperature is a first power, power for heating the cooking chamber in a process of keeping the cooking chamber at the first temperature at the protein hydrolysis stage is a second power, and the first power is greater than the second power. In this way, the first power is relatively large, which is beneficial to quickly heat the cooking chamber, and shorten time for heating the cooking chamber to the first temperature. The second power is relatively small, heat absorbed after it is released by a heater and heat dissipated by the cooking chamber are substantially kept in balance, and the temperature of the cooking chamber substantially remains unchanged. The power for heating the cooking chamber is also referred to as a “heating power.”

In an embodiment, power for heating the cooking chamber in a process of heating the cooking chamber to the second temperature is a third power, power for heating the cooking chamber in a process of keeping the cooking chamber at the second temperature at the fishy smell removal stage is a fourth power, and the third power is greater than the fourth power. In this way, the cooking chamber is heated with a relatively large third power, which is beneficial to quickly heat the cooking chamber to the second temperature, while the cooking chamber is heated with a relatively small fourth power, so that heat absorbed after it is released by the heater and heat dissipated by the cooking chamber are substantially kept in balance, and the temperature of the cooking chamber substantially remains unchanged.

In an embodiment, the cooking chamber is heated by a heater of a cooking device.

In an embodiment, the heater heats the cooking chamber with the first power to heat the cooking chamber to the first temperature, and the heater heats the cooking chamber with the second power to keep the cooking chamber at the first temperature at the protein hydrolysis stage, the first power is greater than the second power.

In an embodiment, the first power may be equal to or greater than 700 W, and the second power may be less than or equal to 400 W.

In an embodiment, after the protein hydrolysis stage, the heater heats the cooking chamber with the third power to heat the cooking chamber to the second temperature, and the heater heats the cooking chamber with the fourth power to keep the cooking chamber at the second temperature at the fishy smell removal stage, the third power is greater than the fourth power.

In an embodiment, the third power may be equal to or greater than 700 W, and the fourth power may be less than or equal to 400 W.

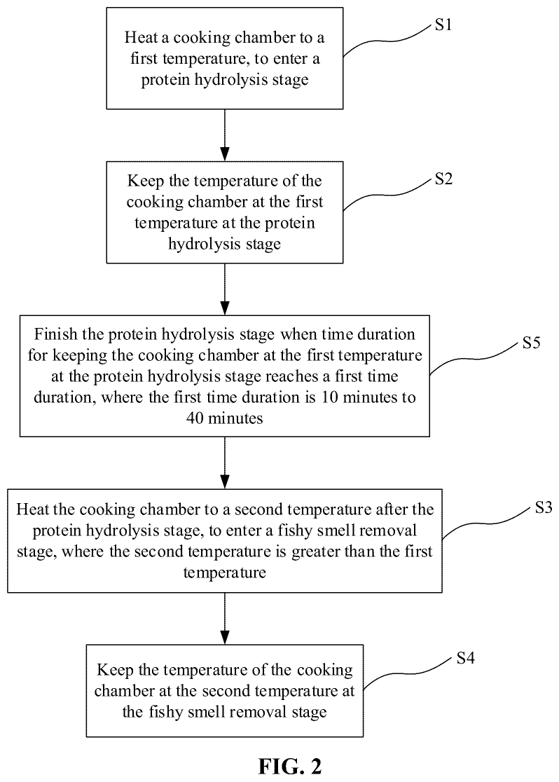

In an embodiment, with reference to FIG. 2, the method for cooking soup further includes the following operation S5.

At S5, the protein hydrolysis stage is finished when time duration for keeping the cooking chamber at the first temperature at the protein hydrolysis stage reaches a first time duration, the first time duration is 10 minutes to 40 minutes. In this way, on one hand, the protein may be fully hydrolyzed at the first temperature, and on the other hand, fishy smell substances in the food may be dissolved into the soup as much as possible.

It should be noted that ‘after the protein hydrolysis stage’ means that it needs to wait for completion of the protein hydrolysis stage, that is, after the protein hydrolysis stage is finished.

It should be noted that the protein is hydrolyzed at the first temperature, and the protein hydrolysis stage is finished, that is, the temperature of the cooking chamber deviates from the first temperature, the temperature of the cooking chamber may be greater than the first temperature, or the temperature of the cooking chamber may be lower than the first temperature.

It may be understood that the first time duration is selected according to actual requirements. For example, the first time duration is selected according to an approximate content of proteins in the food.

Exemplarily, the first time duration may be 10 minutes, 15 minutes, 21 minutes, 25 minutes, 30 minutes, 36 minutes, or 40 minutes.

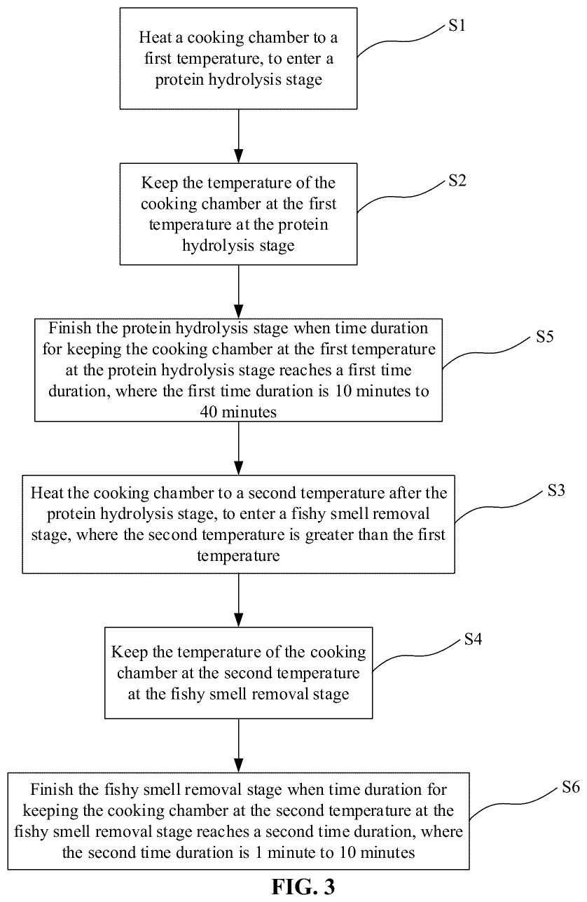

In an embodiment, with reference to FIG. 3, the method for cooking soup further includes the following operation S6.

At S6, the fishy smell removal stage is finished when time duration for keeping the cooking chamber at the second temperature at the fishy smell removal stage reaches a second time duration, the second time duration is 1 minute to 10 minutes. In this way, fishy smell substances in the soup may be volatilized and discharged with vapor as much as possible, few fishy smell substances are remained in the soup, or even no fishy smell substances are remained substantially, achieving a better fishy smell removal effect.

In an embodiment, the second time duration is selected according to actual requirements. For example, the second time duration is selected according to an approximate content of initial fishy smell substances in the food.

It should be noted that the fishy smell substances in the soup are volatilized with vapor at the second temperature, to achieve fishy smell removal, and the fishy smell removal stage is finished, that is, the temperature of the cooking chamber deviates from the second temperature, the temperature of the cooking chamber may be lower than the second temperature, or the temperature of the cooking chamber may be greater than the second temperature.

Exemplarily, the second time duration may be 1 minute, 3 minutes, 6 minutes, 7 minutes, 8 minutes, or 10 minutes.

In an embodiment, the cooking device may be a non-pressure vessel.

It may be understood that the cooking chamber of the non-pressure vessel is not closed and pressurized in the cooking process, and the fishy smell substances volatilized from the soup with vapor at the fishy smell removal stage may be better discharged from the non-pressure vessel.

In an embodiment, the cooking apparatus may be a pressure cooker, pressurization temperature of the cooking chamber is a third temperature, and the third temperature is greater than the second temperature. In this way, when the temperature of the cooking chamber is kept at the second temperature at the fishy smell removal stage, since the third temperature is greater than the second temperature, the cooking chamber has not been closed and pressurized, and the fishy smell substances volatilized from the soup with vapor may be better discharged from the pressure cooker.

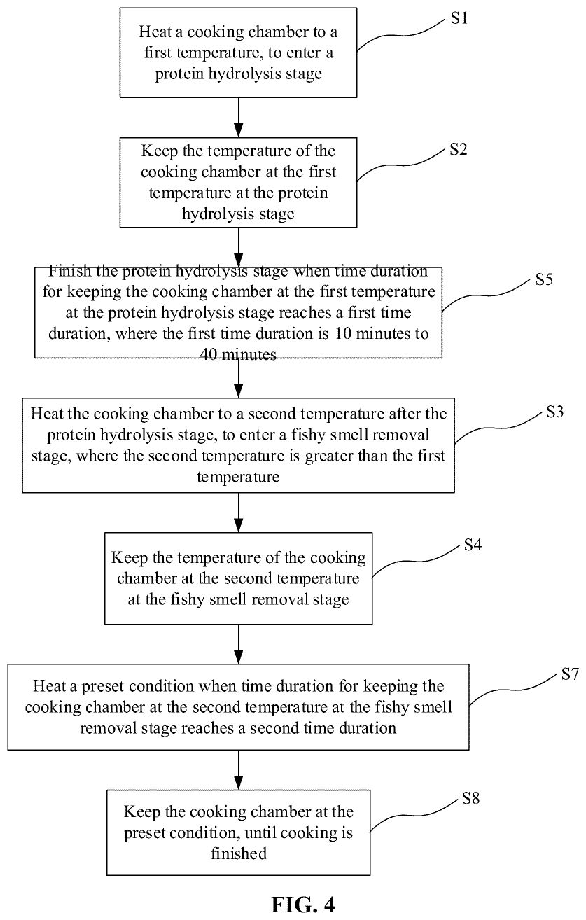

In an embodiment, with reference to FIG. 4, the method for cooking soup further includes the following operations S7 and S8.

At S7, the cooking chamber is heated to a preset condition when time duration for keeping the cooking chamber at the second temperature at the fishy smell removal stage reaches a second time duration.

At S8, the cooking chamber is kept at the preset condition, until cooking is finished.

The preset condition is that the temperature of the cooking chamber is a fourth temperature, and the fourth temperature is greater than the third temperature; and/or, pressure of the cooking chamber is a preset pressure, and the preset pressure is greater than pressure in the cooking chamber at a pressurization time.

It may be understood that when the cooking device is a pressure cooker, temperature in the cooking chamber is positively correlated with pressure, the temperature in the cooking chamber may be obtained by measuring the pressure in the cooking chamber, and the pressure in the cooking chamber may be obtained by measuring the temperature in the cooking chamber. Since the fourth temperature is greater than the third temperature, when the cooking chamber is heated to the fourth temperature, the cooking chamber has been pressurized, and the food is cooked for a period of time under a certain pressure, until cooking is finished. Since the preset pressure is greater than the pressure in the cooking chamber at the pressurization time, when the cooking chamber is heated to the preset pressure, the cooking chamber has been pressurized, and the food is cooked for a period of time under a certain pressure, until cooking is finished. After the fishy smell removal stage, the cooking chamber is closed and pressurized, and the food in the cooking chamber is cooked for a period of time under a certain pressure, so that the food may be cooked quickly and thoroughly, and the soup is more delicious.

It should be noted that since the fourth temperature is greater than the third temperature and the third temperature is greater than the second temperature, heating the cooking chamber to the fourth temperature has deviated from the second temperature, which means that the fishy smell removal stage is finished.

It should be noted that since temperature in the cooking chamber of the pressure cooker is positively correlated with pressure, the temperature in the cooking chamber corresponding to the pressure in the cooking chamber at the pressurization time is substantially the third temperature at which the cooking chamber may be pressurized. The preset pressure is greater than the pressure in the cooking chamber at the pressurization time, that is, the temperature in the cooking chamber corresponding to the preset pressure is greater than the third temperature, and the temperature in the cooking chamber corresponding to the preset pressure has deviated from the second temperature, which means that the fishy smell removal stage is finished.

It should be noted that an exhaust valve is provided on a pot cover of the pressure cooker, and the pressurization time of the cooking chamber is a time when the exhaust valve is switched from an open state to a closed state.

In an embodiment, the exhaust valve is a floater. The cooking chamber is closed by floating of the floater, so that the cooking chamber is pressurized. When the cooking chamber is not pressurized, the floater does not float.

In an embodiment, power for heating the cooking chamber in a process of heating the cooking chamber to the preset condition is a fifth power, power for heating the cooking chamber in a process of keeping the cooking chamber at the preset condition is a sixth power, and the fifth power is greater than the sixth power. In this way, the cooking chamber is heated with a relatively large fifth power to quickly heat the cooking chamber to the preset condition, and the cooking chamber is heated with a relatively small sixth power, so that heat released by the heater and absorbed is substantially equal to heat dissipated by the cooking chamber, and the temperature in the cooking chamber is substantially kept at the preset condition.

In an embodiment, the heater heats the cooking chamber with the fifth power to heat the cooking chamber to the preset condition, and the heater heats the cooking chamber with the sixth power to keep the cooking chamber at the preset condition, the fifth power is greater than the sixth power.

In an embodiment, the fifth power may be equal to or greater than 700 W, and the sixth power may be less than or equal to 400 W.

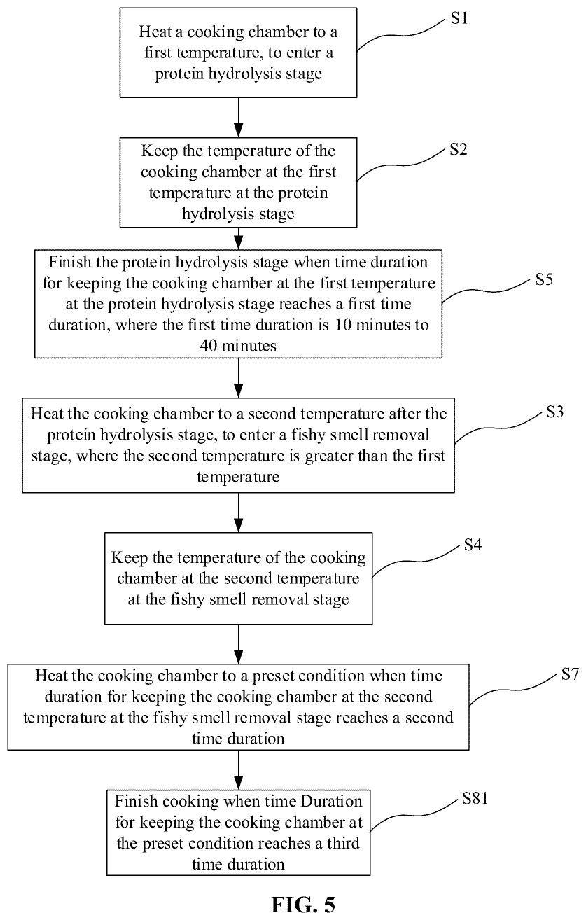

In an embodiment, with reference to FIG. 5, the operation of keeping the cooking chamber at the preset condition, until cooking is finished, includes the following operation S81.

At S81, cooking is finished when time duration for keeping the cooking chamber at the preset condition reaches a third time duration.

In this way, the food has been cooked for enough time under a certain pressure and may be cooked thoroughly, and a delicious soup may be cooked.

Exemplarily, the third time duration may be from 5 minutes to 50 minutes.

It may be understood that the third time duration is set according to requirements of food to be cooked.

Exemplarily, the third time duration may be 5 minutes, 10 minutes, 15 minutes, 20 minutes, 30 minutes, 33 minutes, 46 minutes, or 50 minutes.

In an embodiment, the fourth temperature is equal to or greater than 106° C., and the fourth temperature is less than or equal to 128° C.; and/or, the pressure of the cooking chamber is equal to or greater than 30 KPa, and the pressure of the cooking chamber is less than or equal to 140 KPa. In this way, after the cooking chamber is closed and pressurized, temperature and pressure in the cooking chamber are appropriate, to avoid the pressure in the cooking chamber from becoming too high and exceeding a pressure-bearing limit of the pressure cooker.

Exemplarily, the fourth temperature may be 106° C., 110° C., 113° C., 118° C., 124° C., 126° C., 127° C., or 128° C.

Exemplarily, the pressure of the cooking chamber may be 30 KPa, 40 KPa, 50 KPa, 60 KPa, 75 KPa, 90 KPa, 110 KPa, 125 KPa, 135 KPa, or 140 KPa.

It needs to be explained that specific pressure values mentioned in the embodiments of the disclosure refer to a pressure difference between the pressure of the cooking chamber and a normal pressure, and correspondingly, the pressure of the cooking chamber is a relative pressure relative to the normal pressure. The normal pressure is about 1 atmospheric pressure.

Exemplarily, the pressure of the cooking chamber is equal to or greater than 30 KPa, which means that the pressure difference between the pressure in the cooking chamber and the normal pressure is equal to or greater than 30 KPa.

Exemplarily, the pressure of the cooking chamber is less than or equal to 140 KPa, which means that the pressure difference between the pressure in the cooking chamber and the normal pressure is less than or equal to 140 KPa.

In an embodiment, the first temperature is equal to or greater than 40° C., and the first temperature is less than or equal to 70° C.; and/or, the second temperature is equal to or greater than 92° C., and the second temperature is less than or equal to 100° C. In this way, protein in the food is hydrolyzed at an appropriate first temperature, so that the protein in the food is fully hydrolyzed. The second temperature is relatively high, while does not make the soup in the cooking chamber boiled violently to pressurize the cooking chamber. Fishy smell substances dissolved into the soup at an appropriate second temperature may be better volatilized and discharged with vapor, achieving a better fishy smell removal effect.

Exemplarily, the first temperature may be 40° C., 50° C., 55° C., 60° C., 65° C., 68° C., or 70° C.

Exemplarily, the second temperature may be 92° C., 93° C., 94° C., 95° C., 96° C., 97° C., 98° C., 99° C., or 100° C.

Components of soup cooked by using the method of the embodiment of the disclosure and components of soup in a comparative example cooked without using the method of the embodiment of the disclosure, are shown in the following table.

| | | Method of the | |
|---|---|---|---|
| | | embodiment | Comparative |
| Indicator | | of the disclosure | example |
| Content | Aspartic acid | 16.98 | 14.65 |
| of amino | Glutamate | 17.12 | 14.02 |
| acid (mg/L) | Total umami | 146.21 | 121.35 |
| | amino acid | | |
| Electronic | Umami taste | 12.82 | 10.65 |
| tongue test | Richness | 4.12 | 3.65 |
| | Salty taste | 5.42 | 5.36 |
| | Fishy smell | 2.56 | 3.21 |

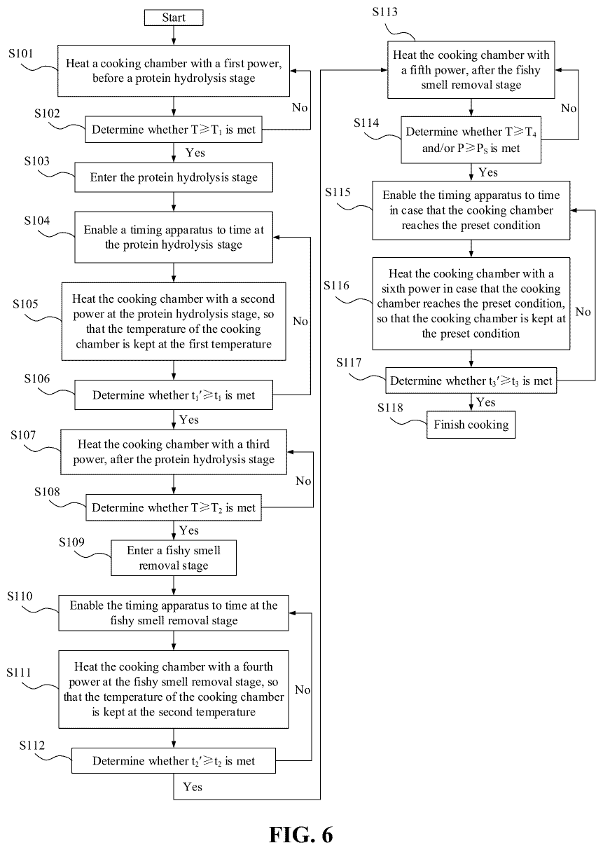

Specific execution operations of a method for cooking soup are explained by an embodiment shown in FIG. 6.

At S101, a cooking chamber is heated with a first power, before a protein hydrolysis stage.

At S102, it is determined whether temperature of the cooking chamber reaches a first temperature. If yes, S103 is executed; and if no, S101 is executed.

It needs to be explained that the temperature in the cooking chamber is T, and the first temperature is T₁.

At S103, the protein hydrolysis stage is entered.

At S104, a timing apparatus is enabled to time at the protein hydrolysis stage.

At S105, the cooking chamber is heated with a second power at the protein hydrolysis stage, so that the temperature of the cooking chamber is kept at the first temperature.

At S106, it is determined whether time recorded by the timing apparatus at the protein hydrolysis stage reaches a first time duration. If yes, S107 is executed; and if no, S104 is executed.

It needs to be explained that the time recorded by the timing apparatus at the protein hydrolysis stage is t₁′, and the first time duration is t₁.

At S107, the cooking chamber is heated with a third power, after the protein hydrolysis stage.

At S108, it is determined whether the temperature of the cooking chamber reaches a second temperature. If yes, S109 is executed; and if no, S107 is executed.

It needs to be explained that the second temperature is T₂.

At S109, a fishy smell removal stage is entered.

At S110, the timing apparatus is enabled to time at the fishy smell removal stage.

At S111, the cooking chamber is heated with a fourth power at the fishy smell removal stage, so that the temperature of the cooking chamber is kept at the second temperature.

At S112, it is determined whether time recorded by the timing apparatus at the fishy smell removal stage reaches a second time duration. If yes, S113 is executed; and if no, S110 is executed.

It needs to be explained that the time recorded by the timing apparatus at the fishy smell removal stage is t₂′, and the second time duration is t₂.

At S113, the cooking chamber is heated with a fifth power, after the fishy smell removal stage.

At S114, it is determined whether the cooking chamber is heated to a preset condition. If yes, S115 is executed; and if no, S113 is executed.

It needs to be explained that the preset condition is: the temperature of the cooking chamber is a fourth temperature, and the fourth temperature is greater than a third temperature; and/or, pressure of the cooking chamber is a preset pressure, and the preset pressure is greater than pressure in the cooking chamber at a pressurization time.

It needs to be explained that the fourth temperature is T₄, the pressure of the cooking chamber is P, and the preset pressure is P_{S}.

At S115, the timing apparatus is enabled to time in case that the cooking chamber reaches the preset condition.

At S116, the cooking chamber is heated with a sixth power in case that the cooking chamber reaches the preset condition, so that the cooking chamber is kept at the preset condition.

At S117, it is determined whether time recorded by the timing apparatus in case that the cooking chamber is kept at the preset condition reaches a third time duration. If yes, S118 is executed; and if no, S115 is executed.

It needs to be explained that the time recorded by the timing apparatus in case that the cooking chamber is kept at the preset condition is t₃′, and the third time duration is t₃.

At S118, cooking is finished.

A second aspect of the embodiments of the disclosure provides a cooking apparatus, the cooking apparatus includes a first heating module, a first heat preservation module, a second heating module, and a second heat preservation module. The first heating module is configured to heat a cooking chamber to a first temperature, to enter a protein hydrolysis stage. The first heat preservation module is configured to keep the temperature of the cooking chamber at the first temperature at the protein hydrolysis stage. The second heating module is configured to heat the cooking chamber to a second temperature after the protein hydrolysis stage, to enter a fishy smell removal stage, the second temperature is greater than the first temperature. The second heat preservation module is configured to keep the temperature of the cooking chamber at the second temperature at the fishy smell removal stage. In this way, at the protein hydrolysis stage, not only the protein may be hydrolyzed, but also fishy smell substances in the food may be dissolved into the soup as much as possible, which facilitates the fishy smell substances to be quickly volatilized and discharged with vapor at subsequent fishy smell removal stage.

In an embodiment, the cooking apparatus further includes a third heating module, the third heating module is configured to heat the cooking chamber to a preset condition when time duration for keeping the cooking chamber at the second temperature at the fishy smell removal stage reaches a second time duration. The preset condition is that the temperature of the cooking chamber is a fourth temperature, and the fourth temperature is greater than the third temperature; and/or, pressure of the cooking chamber is a preset pressure, and the preset pressure is greater than pressure in the cooking chamber at a pressurization time.

In an embodiment, the cooking apparatus further includes a maintenance module, the maintenance module is configured to keep the cooking chamber at the preset condition, until cooking is finished.

A third aspect of the embodiments of the disclosure provides a cooking device, the cooking device includes a memory and a processor. The memory stores a computer-executable instruction. The processor is configured to execute the computer-executable instruction stored in the memory, to implement operations of the method of any one of the above embodiments.

A fourth aspect of the embodiments of the disclosure provides a storage medium, the storage medium stores a computer-executable instruction, the computer-executable instruction is configured to be executed by a processor to implement operations of the method of any one of the above embodiments.

In an embodiment, the computer-readable storage medium may be a memory such as a Ferroelectric Random Access Memory (FRAM), a Read-Only Memory (ROM), a Programmable Read-Only Memory (PROM), an Erasable Programmable Read-Only Memory (EPROM), an Electrically Erasable Programmable Read-Only Memory (EEPROM), a flash memory, a magnetic surface memory, a Compact Disc (CD), or a Compact Disc Read-Only Memory (CD-ROM), or the like; or may be various devices including one of the above memories or any combination thereof.

In an embodiment, the executable instruction may be in form of program, software, software module, script or code; written in any form of programming language (including compiled or interpreted language, or declarative or procedural language); and may be deployed in any form, including that it is deployed as an independent program, or deployed as module, component, subroutine, or other units applicable to be used in a computer environment.

Exemplarily, the executable instruction may, but does not necessarily correspond to a file in a file system; and may be stored in a part of a file storing other programs or data, for example, stored in one or more scripts in a Hyper Text Markup Language (HTML) document, in a single file dedicated to a discussed program, or in multiple collaborative files.

Exemplarily, the executable instruction may be deployed to be executed on one computing device, or on multiple computing devices located at one location, or on multiple computing devices distributed at multiple locations and interconnected through a network.

The above descriptions are only preferred embodiments of the disclosure, and are not intended to limit the disclosure. The disclosure may be subject to various modifications and variations for those skilled in the art. Any modification, equivalent replacement, improvement, or the like made within the spirit and principle of the disclosure shall be included in the scope of protection of the disclosure.

1. A method for cooking comprising:
heating a cooking chamber of a cooking device to a first temperature, to enter a first cooking stage;
keeping a temperature of the cooking chamber at the first temperature at the first cooking stage;
heating the cooking chamber to a second temperature after the first cooking stage, to enter a second cooking stage, the second temperature being greater than the first temperature; and
keeping the temperature of the cooking chamber at the second temperature at the second cooking stage.

2. The method of claim 1, further comprising:
finishing the first cooking stage in response to the cooking chamber having been kept at the first temperature at the first cooking stage for a time duration in a range from 10 minutes to 40 minutes.

3. The method of claim 1, further comprising:
finishing the second cooking stage in response to the cooking chamber having been kept at the second temperature at the second cooking stage for a time duration in a range from 1 minute to 10 minutes.

4. The method of claim 1, wherein the cooking device includes a pressure cooker, a pressurization temperature of the cooking chamber is a third temperature, and the third temperature is greater than the second temperature.

5. The method of claim 4, further comprising:
heating the cooking chamber to a preset condition in response to the cooking chamber having been kept at the second temperature at the second cooking stage for a certain time duration; and
keeping the cooking chamber at the preset condition, until cooking is finished;
wherein the preset condition includes at least one of:
the temperature of the cooking chamber being a fourth temperature greater than the third temperature; or
a pressure of the cooking chamber being a preset pressure greater than a pressure in the cooking chamber at a pressurization time.

6. The method of claim 5, wherein:
the fourth temperature is greater than or equal to 106° C. and less than or equal to 128° C.; and/or
the pressure of the cooking chamber is equal to or greater than 30 KPa and less than or equal to 140 KPa.

7. The method of claim 5, wherein a first heating power in a process of heating the cooking chamber to the preset condition is greater than a second heating power in a process of keeping the cooking chamber at the preset condition.

8. The method of claim 7, wherein the first heating power is equal to or greater than 700 W, and the second heating power is less than or equal to 400 W.

9. The method of claim 1, wherein the first temperature is greater than or equal to 40° C. and less than or equal to 70° C.

10. The method of claim 1, wherein the second temperature is greater than or equal to 92° C. and less than or equal to 100° C.

11. The method of claim 1, wherein a first heating power in a process of heating the cooking chamber to the first temperature is greater than a second heating power in a process of keeping the cooking chamber at the first temperature at the first cooking stage.

12. The method of claim 11, wherein the first heating power is equal to or greater than 700 W, and the second heating power is less than or equal to 400 W.

13. The method of claim 1, wherein a first heating power in a process of heating the cooking chamber to the second temperature is greater than a second heating power in a process of keeping the cooking chamber at the second temperature at the second cooking stage.

14. The method of claim 13, wherein the first heating power is greater than or equal to 700 W, and the second heating power is less than or equal to 400 W.

15. A non-transitory computer-readable storage medium, storing one or more computer-executable instructions that, when executed by one or more processors of a cooking device, cause the cooking device to:
heat a cooking chamber of the cooking device to a first temperature, to enter a first cooking stage;
keep a temperature of the cooking chamber at the first temperature at the first cooking stage;
heat the cooking chamber to a second temperature after the first cooking stage, to enter a second cooking stage, the second temperature being greater than the first temperature; and
keep the temperature of the cooking chamber at the second temperature at the second cooking stage.

16. A cooking device comprising:
one or more memories storing one or more computer-executable instructions; and
one or more processors configured to execute the one or more computer-executable instructions to cause the cooking device to:
heat a cooking chamber of the cooking device to a first temperature, to enter a first cooking stage;
keep a temperature of the cooking chamber at the first temperature at the first cooking stage;
heat the cooking chamber to a second temperature after the first cooking stage, to enter a second cooking stage, the second temperature being greater than the first temperature; and
keep the temperature of the cooking chamber at the second temperature at the second cooking stage.

17. The cooking device of claim 16, wherein the one or more processors are further configured to execute the one or more computer-executable instructions to cause the cooking device to:
finish the first cooking stage in response to the cooking chamber having been kept at the first temperature at the first cooking stage for a time duration in a range from 10 minutes to 40 minutes.

18. The cooking device of claim 16, wherein the one or more processors are further configured to execute the one or more computer-executable instructions to cause the cooking device to:
finish the second cooking stage in response to the cooking chamber having been kept at the second temperature at the second cooking stage for a time duration in a range from 1 minute to 10 minutes.

19. The cooking device of claim 16, wherein the cooking device includes a pressure cooker, a pressurization temperature of the cooking chamber is a third temperature, and the third temperature is greater than the second temperature.

20. The cooking device of claim 19, wherein:
the one or more processors are further configured to execute the one or more computer-executable instructions to cause the cooking device to:
heat the cooking chamber to a preset condition in response to the cooking chamber having been kept at the second temperature at the second cooking stage for a certain time duration; and
keep the cooking chamber at the preset condition, until cooking is finished; and
the preset condition includes at least one of:
the temperature of the cooking chamber being a fourth temperature greater than the third temperature; or
a pressure of the cooking chamber being a preset pressure greater than a pressure in the cooking chamber at a pressurization time.
